(19) United States
(12) Patent Application Publication
(10) Pub. No.: US 2012/0072163 A1
(43) Pub. Date: Mar. 22, 2012

(54) THERMOSTAT CONFIGURED FOR PROVIDING BUILDING ENVELOPE ANALYSIS AND METHOD THEREOF

(76) Inventor: Haorong Li, Omaha, NE (US)

(21) Appl. No.: 12/885,422

(22) Filed: Sep. 17, 2010

(51) Int. Cl. G06F 15/00; G01N 25/00

(52) U.S. Cl. 702/136

(57) ABSTRACT

A method for analyzing a building envelope. The method comprises calculating a thermal decay time (TDT) based on: an equipment off time during a work cycle, an ambient temperature, a thermostat set point temperature, and a thermostat set point dead-band; calculating at least one of: a building load factor (BLF) under a calm condition based on the TDT, and a BLF under a windy condition based on the TDT; providing a normal BLF for a calm condition; and analyzing the building envelope for at least one of: a quality of building envelope insulation, and whether the building envelope is leaking; wherein the quality of building envelope insulation is determined based on the BLF under the calm condition and the normal BLF for the calm condition, and whether the building envelope is leaking is determined based on the BLF under the windy condition and the BLF under the calm condition.

### TECHNICAL FIELD

The disclosure generally relates to the field of electronic thermostats, particularly to a thermostat capable of providing building envelope analysis.

### BACKGROUND

A thermostat is a device for regulating the temperature of a building system so that the temperature is maintained near a desired set point temperature. The thermostat does this by switching temperature/climate control equipment (e.g., heating or cooling devices) on or off, to maintain the temperature around the desired set point. The duration of which the temperature control equipment changes from a first state (e.g., OFF state) to a second state (e.g., ON state) till the next time the temperature control equipment changes from the first state (e.g., OFF state) to the second state (e.g., ON state) may be referred to as a work cycle.

A building envelope is the separation between the interior and the exterior environments of a building. The building envelope may serves as the outer shell to protect the indoor environment as well as to facilitate its climate control. Temperature control is one of the performance objectives of building envelope design includes. Having a poorly insulated and/or leaking building envelope may affect the temperature control, comfort and energy usage greatly.

### SUMMARY

The present disclosure is directed to a method for analyzing a building envelope. The method may comprise calculating a thermal decay time (TDT) at least partially based on: an equipment off time during a temperature control equipment work cycle, an ambient temperature, a set point temperature of a thermostat, and a set point dead-band of the thermostat; calculating at least one of: a building load factor (BLF) under a calm condition at least partially based on the TDT, and a BLF under a windy condition at least partially based on the TDT; providing a normal BLF for a calm condition; and analyzing the building envelope for at least one of: a quality of building envelope insulation, and whether the building envelope is leaking; wherein the quality of building envelope insulation is determined based on the BLF under the calm condition and the normal BLF for the calm condition, and whether the building envelope is leaking is determined based on the BLF under the windy condition and the BLF under the calm condition.

A further embodiment of the present disclosure is directed to method for analyzing a building envelope. The method may comprise calculating a thermal decay time (TDT) at least partially based on: an equipment off time during a temperature control equipment work cycle, an ambient temperature, a set point temperature of a thermostat, and a set point dead-band of the thermostat; calculating at least one of: a building load factor (BLF) under a calm condition at least partially based on the TDT, and a BLF under a windy condition at least partially based on the TDT; calculating a normal BLF for a calm condition as a function of building insulation and stack effect; and analyzing the building envelope for at least one of: a quality of building envelope insulation, and whether the building envelope is leaking; wherein the quality of building envelope insulation is determined based on the BLF under the calm condition and the normal BLF for the calm condition, and whether the building envelope is leaking is determined based on the BLF under the windy condition and the BLF under the calm condition.

An additional embodiment of the present disclosure is directed to a thermostat. The thermostat may comprise a temperature control module configured for determining: an equipment off time during a temperature control equipment work cycle, an ambient temperature, a set point temperature of the thermostat, and a set point dead-band of the thermostat. The thermostat may also comprise a computing module. The computing module is configured for calculating a thermal decay time (TDT) at least partially based on: the equipment off time during a temperature control equipment work cycle, the ambient temperature, the set point temperature of the thermostat, and a set point dead-band of the thermostat. The computing module is further configured for calculating at least one of: a building load factor (BLF) under a calm condition at least partially based on the TDT, a BLF under a windy condition at least partially based on the TDT, and a normal BLF for a calm condition. The thermostat may further comprise a building envelope analysis module configured for analyzing a building envelope for at least one of: a quality of building envelope insulation, and whether the building envelope is leaking, wherein the quality of building envelope insulation is determined based on the BLF under the calm condition and the normal BLF for the calm condition, and whether the building envelope is leaking is determined based on the BLF under the windy condition and the BLF under the calm condition.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for analyzing a building envelope;

FIG. 2 is a flow diagram illustrating a method for analyzing the quality of building envelope insulation;

FIG. 3 is a flow diagram illustrating a method for analyzing whether the building envelope is leaking; and

FIG. 4 is an illustration depicting a thermostat configured for analyzing a building envelope.

### DETAILED DESCRIPTION

Reference will now be made in detail to the subject matter disclosed, which is illustrated in the accompanying drawings.

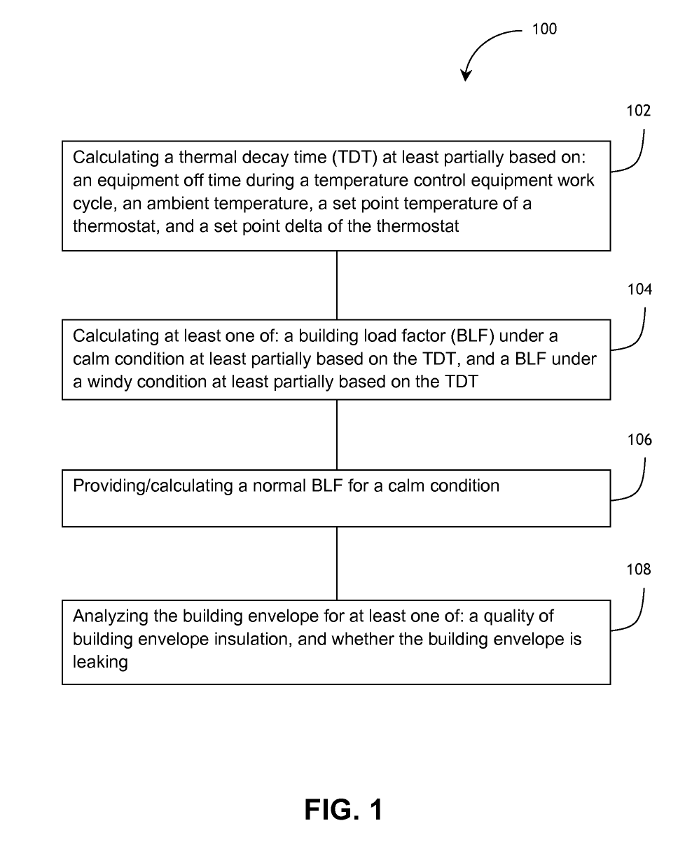

The present disclosure is directed to a method and a thermostat configured for providing building envelope analysis. Referring to FIG. 1, a flow diagram illustrating a building envelope analysis method 100 is shown. A thermal decay time (TDT) is calculated in step 102. In one embodiment, the TDT is calculated based on the following equation:

$$TDT = \frac{{t}_{off} ( {T}_{sp} - {T}_{oa} )}{Δ {T}_{sp}}$$

Where t_{off} represents the equipment off time during a temperature control equipment work cycle; Tₒₐ represents an ambient temperature (e.g., an outdoor/exterior temperature); Tₛₚ represents a set point temperature of the thermostat; and ΔTₛₚ represents a set point dead-band or hysteresis of the thermostat.

The set point dead-band (ΔTₛₚ) depicts the difference between the temperatures at which the equipment is turned on and off. For example, in heating mode, the heating system may be configured to turn on when the temperature drops two degrees below the set point (instead turning on immediately when the temperature drops to the set point). The difference between the turn on temperature and the set point (two degrees in this example) may be referred to as the set point dead-band (ΔTₛₚ). It is contemplated that the set point dead-band of a particular thermostat may be preconfigured and/or adjustable. The value of the set point dead-band (ΔTₛₚ) may be provided by the thermostat any time prior to or at the time of the TDT calculation.

The TDT calculated in step 102 may represent an inherent characteristic of the building envelope, including building envelope and building thermal mass, and a quantity related to: the frame of the house (e.g., wood, masonry or metal); quality of installation of insulation; and ratio of space volume to envelope surface. Ideally, the TDT should remain a constant for a given well-designed building, and the greater the TDT, the better the building envelope characteristic. Therefore, if the TDT decreases, it may suggest that the building envelope may have degraded.

Once the TDT is calculated, step 104 may calculate one or more building load factors (BLF) based on the TDT. In one embodiment, the BLF is calculated based on the following equation:

$$BLF = \frac{{C}_{b} / A}{TDT}$$

Where A represents the building envelope surface area; and C_{b} represents the building thermal mass. It is understood that both A and C_{b} may be obtained/calculated utilizing various conventional techniques without departing from the spirit and scope of the present disclosure.

It is contemplated that the BLF may vary based on environmental conditions. For example, the BLF calculated under a calm condition (e.g., with wind speed less than 3 miles/minute) may differ from the BLF calculated under a windy condition (e.g., with wind speed greater than or equal to 10 miles/minute). Step 104 may calculate only BLF_{calm}, only BLF_{windy}, or both BLF_{calm} and BLF_{windy}, based on the type of analysis to be performed (as described below).

In addition to calculating BLF_{calm} and/or BLF_{windy}, an ideal building load factor (may also be referred to as normal BLF) for the building envelope may be provided in step 106 as a reference for comparing against the calculated BLFs. The normal BLF for a calm condition (BLF_{calm,normal}) may be provided as specified values associated with the design of the building envelope (e.g., a design parameter based on ideal conditions), or may be calculated as a function of the building insulation and the stack effect. For example, the value of BLF_{calm,normal} may be calculated as

$$\frac{\sum {U}_{design , i} {A}_{i}}{\sum {A}_{i}} ,$$

where i represents a portion of the building (e.g., the building may be divided into multiple portions/zones); Aᵢ represents the surface area for the particular portion of the building; and U_{design,i} represents the U-value for the particular portion of the building.

Step 108 may perform building envelope analysis based on the BLF values. For example, step 108 may analyze the quality of building envelope insulation based on the values of BLF_{calm} and BLF_{calm,normal}. Additionally/alternatively, step 108 may also analyze whether the building envelope is leaking based on the values of BLF_{calm} and BLF_{windy}.

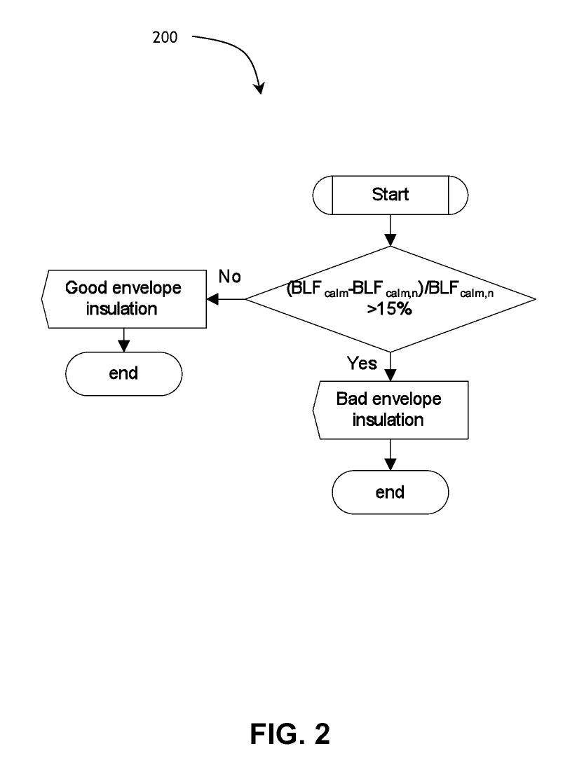

Referring to FIG. 2, a flow diagram illustrating a method 200 for analyzing the quality of building envelope insulation is shown. In one embodiment, the method 200 may calculate the value of

$$\frac{{BLF}_{calm} - {BLF}_{calm , normal}}{{BLF}_{calm , normal}}$$

and compare the result against a predetermined threshold. If the result is greater than the threshold, the quality of the building envelope may be deemed “bad”; otherwise, the quality of the building envelope may be deemed “good”. The predetermined threshold in a particular implementation is configured such that if the value of BLF_{calm}−BLF_{calm,normal} is more than 15% greater than the value of BLF_{calm, normal}, then the quality of the building envelope is deemed “bad”. It is contemplated that the threshold may vary based on specific implementation. It is also contemplated that the determination of the quality of the building envelope is not limited to a binary decision (e.g., good or bad), and that a multi-tiered assessment (e.g., excellent, good, fair, and poor) may be utilized without departing from the spirit and scope of the present disclosure.

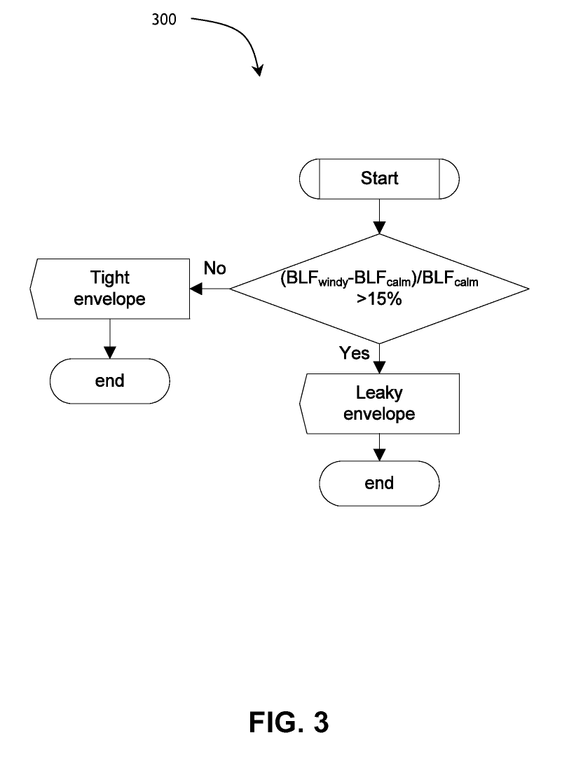

Referring to FIG. 3, a flow diagram illustrating a method 300 for analyzing whether the building envelope is leaking is shown. In one embodiment, the method 300 may calculate the value of

$$\frac{{BLF}_{windy} - {BLF}_{calm}}{{BLF}_{calm}}$$

and compare the result against a predetermined threshold. If the result is greater than the threshold, it may suggest that the building envelope is leaking; otherwise, it may suggest that no significant leaking is detected. The predetermined threshold in a particular implementation is configured such that if the value of BLF_{windy}−BLF_{calm} is more than 15% greater than the value of BLF_{calm}, then the building envelope is deemed leaking. It is contemplated that the threshold may vary based on specific implementation. It is also contemplated that the determination of whether the building envelope is leaking is not limited to a binary decision (e.g., leaking or not leaking), and that a multi-tiered assessment (e.g., severe, moderate and airtight) may be utilized without departing from the spirit and scope of the present disclosure.

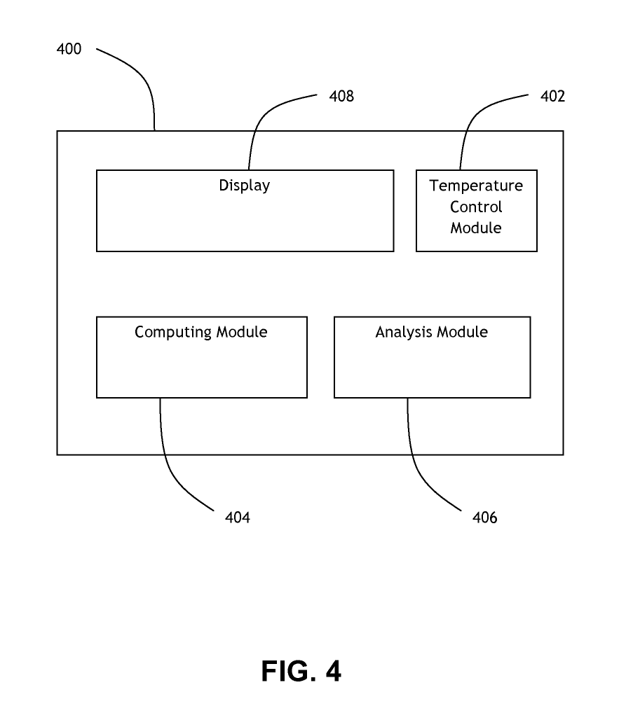

Referring to FIG. 4, an illustration depicting a thermostat 400 configured for analyzing a building envelope is shown. The thermostat 400 may include a temperature control module 402 for controlling/maintaining the temperature near a desired set point temperature. For example, the temperature control module may turn a piece of equipment (e.g., heating or cooling devices) on or off to maintain the temperature around the desired set point. In one embodiment, the temperature control module 402 is configured for determining equipment off time during a work cycle, a set point temperature of the thermostat, a set point dead-band of the thermostat, and an ambient temperature (e.g., utilizing an outdoor temperature sensor, or receiving the current outdoor temperature from a weather station via a wired/wireless network).

The thermostat 400 further includes a computing module 404 configured for calculating the thermal decay time (TDT) base on the equipment off time during a work cycle, the set point temperature of the thermostat, the set point dead-band of the thermostat, and the ambient temperature. In one embodiment, the thermal decay time is calculated according to the equation of TDT described above. The computing module 404 is further configured for calculating the BLF under a calm condition (BLF_{calm}), the BLF under a windy condition (BLF_{windy}), or both, based on the type of analysis to be performed. In addition to calculating the BLF_{calm} and BLF_{windy}, ideal building load factor (may also be referred to as normal BLF) for the building envelope may also be calculated. In one embodiment, the normal BLF for calm condition (BLF_{calm,normal}) is calculated as a function of the building insulation and the stack effect. The value of BLF_{calm,normal} may be calculated in real-time when performing the building envelope analysis, or may be calculated and/or provided ahead of time and recorded as lookup values for the analysis.

The thermostat 400 further includes an analysis module 406 configured for determining the quality of building envelope insulation. In one embodiment, the quality of building envelope insulation is determined based on the BLF under calm condition (BLF_{calm}) and the normal BLF for calm condition (BLF_{calm,normal}), as previously described. In addition, the analysis module 406 may be further configured for determining whether the building envelope is leaking. In one embodiment, whether the building envelope is leaking is determined based on the BLF under windy condition (BLF_{windy}) and the BLF under calm condition (BLF_{calm}), as previously described.

The thermostat 400 may further include a display 408. The display 408 may serve as a user interface and/or providing information regarding results of the building envelope analysis. It is contemplated that information regarding results of the building envelope analysis may also be presented via electronic messages (e.g., text messages, electronic mails, or the like). Furthermore, in an event where immediate attention may be needed, a notification may be sent to indicate the issue that need to be addressed. The analysis results and/or notifications may be provided in the forms of an audible signal (e.g., an alarm or a speaker communicatively coupled with the thermostat 400), a visual signal (e.g., via the display 408 or LED indicators), and/or an electronic data signal (e.g., text messages, electronic mails, or the like).

It is contemplated that the temperature control module 402, the computing module 404 and the analysis module 406 may be implemented as separate and interconnected hardware components. Alternatively, they may correspond to various functional aspects of an integrated control device. It is understood that each module may be implemented as either a hardware component or a firmware/software component without departing from the spirit and scope of the present disclosure.

It is believed that the system and method of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

What is claimed is:

1. A method for analyzing a building envelope, comprising:
calculating a thermal decay time (TDT) at least partially based on: an equipment off time during a temperature control equipment work cycle, an ambient temperature, a set point temperature of a thermostat, and a set point dead-band of the thermostat;
calculating at least one of: a building load factor (BLF) under a calm condition at least partially based on the TDT, and a BLF under a windy condition at least partially based on the TDT;
providing a normal BLF for a calm condition; and
analyzing the building envelope for at least one of: a quality of building envelope insulation, and whether the building envelope is leaking;
wherein the quality of building envelope insulation is determined based on the BLF under the calm condition and the normal BLF for the calm condition, and whether the building envelope is leaking is determined based on the BLF under the windy condition and the BLF under the calm condition.

2. The method of claim 1, wherein the TDT is calculated based on the equipment off time during the temperature control equipment work cycle (t_{off}), the ambient temperature (Tₒₐ), the set point temperature of the thermostat (Tₛₚ), and the set point dead-band of the thermostat (ΔTₛₚ) according to equation:
$$T D T = \frac{{t}_{off} ( {T}_{sp} - {T}_{oa} )}{Δ {T}_{sp}} .$$

3. The method of claim 1, wherein the BLF under the calm condition is calculated as
$$B L F = \frac{{C}_{b} / A}{T D T}$$
when wind speed is less than 3 miles/minute, and the BLF under the windy condition is calculated as
$$B L F = \frac{{C}_{b} / A}{T D T}$$
when wind speed is greater than or equal to 10 miles/minute.

4. The method of claim 1, wherein the quality of building envelope insulation is determined based on the BLF under the calm condition (BLF_{calm}) and the normal BLF for the calm condition (BLF_{calm,normal}) according to equation:
$$\frac{{BLF}_{calm} - {BLF}_{calm , normal}}{{BLF}_{calm , normal}} .$$

5. The method of claim 4, wherein the quality of building envelope insulation is deemed bad when BLF_{calm}−BLF_{calm,normal} is more than 15% greater than BLF_{calm,normal}.

6. The method of claim 1, wherein whether the building envelope is leaking is determined based on the BLF under the windy condition (BLF_{windy}) and the BLF under the calm condition (BLF_{calm}) according to equation:
$$\frac{{BLF}_{windy} - {BLF}_{calm}}{{BLF}_{calm}} .$$

7. The method of claim 6, wherein the building envelope is deemed leaking when BLF_{windy}−BLF_{calm} is more than 15% greater than BLF_{calm}.

8. A method for analyzing a building envelope, comprising:
calculating a thermal decay time (TDT) at least partially based on: an equipment off time during a temperature control equipment work cycle, an ambient temperature, a set point temperature of a thermostat, and a set point dead-band of the thermostat;
calculating at least one of: a building load factor (BLF) under a calm condition at least partially based on the TDT, and a BLF under a windy condition at least partially based on the TDT;
calculating a normal BLF for a calm condition as a function of building insulation and stack effect; and
analyzing the building envelope for at least one of: a quality of building envelope insulation, and whether the building envelope is leaking;
wherein the quality of building envelope insulation is determined based on the BLF under the calm condition and the normal BLF for the calm condition, and whether the building envelope is leaking is determined based on the BLF under the windy condition and the BLF under the calm condition.

9. The method of claim 8, wherein the TDT is calculated based on the equipment off time during the temperature control equipment work cycle (t_{off}), the ambient temperature (Tₒₐ), the set point temperature of the thermostat (Tₛₚ), and the set point dead-band of the thermostat (ΔTₛₚ) according to equation:
$$T D T = \frac{{t}_{off} ( {T}_{sp} - {T}_{oa} )}{Δ {T}_{sp}} .$$

10. The method of claim 8, wherein the BLF under the calm condition is calculated as
$$B L F = \frac{{C}_{b} / A}{T D T}$$
when wind speed is less than 3 miles/minute, and the BLF under the windy condition is calculated as
$$B L F = \frac{{C}_{b} / A}{T D T}$$
when wind speed is greater than or equal to 10 miles/minute.

11. The method of claim 8, wherein the quality of building envelope insulation is determined based on the BLF under the calm condition (BLF_{calm}) and the normal BLF for the calm condition (BLF_{calm,normal}) according to equation:
$$\frac{{BLF}_{calm} - {BLF}_{calm , normal}}{{BLF}_{calm , normal}} .$$

12. The method of claim 11, wherein the quality of building envelope insulation is deemed bad when BLF_{calm}−BLF_{calm,normal} is more than 15% greater than BLF_{calm,normal}.

13. The method of claim 8, wherein whether the building envelope is leaking is determined based on the BLF under the windy condition (BLF_{windy}) and the BLF under the calm condition (BLF_{calm}) according to equation:
$$\frac{{BLF}_{windy} - {BLF}_{calm}}{{BLF}_{calm}} .$$

14. The method of claim 13, wherein the building envelope is deemed leaking when BLF_{windy}−BLF_{calm} is more than 15% greater than BLF_{calm}.

15. A thermostat, comprising:
a temperature control module configured for determining: an equipment off time during a temperature control equipment work cycle, an ambient temperature, a set point temperature of the thermostat, and a set point dead-band of the thermostat;
a computing module configured for calculating a thermal decay time (TDT) at least partially based on: the equipment off time during a temperature control equipment work cycle, the ambient temperature, the set point temperature of the thermostat, and a set point dead-band of the thermostat;
the computing module further configured for calculating at least one of: a building load factor (BLF) under a calm condition at least partially based on the TDT, a BLF under a windy condition at least partially based on the TDT, and a normal BLF for a calm condition; and
a building envelope analysis module configured for analyzing a building envelope for at least one of: a quality of building envelope insulation, and whether the building envelope is leaking;
wherein the quality of building envelope insulation is determined based on the BLF under the calm condition and the normal BLF for the calm condition, and whether the building envelope is leaking is determined based on the BLF under the windy condition and the BLF under the calm condition.

16. The thermostat of claim 15, wherein the TDT is calculated based on the equipment off time during the temperature control equipment work cycle (t_{off}), the ambient temperature (Tₒₐ), the set point temperature of the thermostat (Tₛₚ), and the set point dead-band of the thermostat (ΔTₛₚ) according to equation:
$$T D T = \frac{{t}_{off} ( {T}_{sp} - {T}_{oa} )}{Δ {T}_{sp}} .$$

17. The thermostat of claim 15, wherein the BLF under the calm condition is calculated as
$$B L F = \frac{{C}_{b} / A}{T D T}$$
when wind speed is less than 3 miles/minute, and the BLF under the windy condition is calculated as
$$B L F = \frac{{C}_{b} / A}{T D T}$$
when wind speed is greater than or equal to 10 miles/minute.

18. The thermostat of claim 15, wherein the quality of building envelope insulation is determined based on the BLF under the calm condition (BLF_{calm}) and the normal BLF for the calm condition (BLF_{calm,normal}) according to equation:
$$\frac{{BLF}_{calm} - {BLF}_{calm , normal}}{{BLF}_{calm , normal}} .$$

19. The thermostat of claim 15, wherein whether the building envelope is leaking is determined based on the BLF under the windy condition (BLF_{windy}) and the BLF under the calm condition (BLF_{calm}) according to equation:
$$\frac{{BLF}_{windy} - {BLF}_{calm}}{{BLF}_{calm}} .$$

20. The thermostat of claim 15, wherein the analysis module is further configured for presenting a result of the analysis as at least one of: an audio signal, a visual signal, and an electronic data signal.
